(19) United States
(12) Patent Application Publication
(10) Pub. No.: US 2026/0151756 A1
(43) Pub. Date: Jun. 4, 2026

(54) METHOD FOR PREPARING CATALYST USING RECYCLED WASTE BATTERIES AND APPLICATION OF THE CATALYST

(71) Applicant: Guizhou Normal University, Guiyang City (CN)

(72) Inventors: Wei Gong, Guiyang City (CN); Mo Liu, Guiyang City (CN); Yang Dai, Guiyang City (CN); Zhen Yao, Guiyang City (CN)

(21) Appl. No.: 18/966,579

(22) Filed: Dec. 3, 2024

(51) Int. Cl. B01J 23/89; B01J 35/30; B01J 35/40; B01J 37/00; B01J 37/02; B01J 37/04; B01J 37/08; C22B 7/00; H01M 10/54

(52) U.S. Cl. CPC B01J 23/8986; B01J 35/397; B01J 35/40; B01J 37/0036; B01J 37/0236; B01J 37/04; B01J 37/08; C22B 7/007; H01M 10/54

(57) ABSTRACT

Provided herein is a method for preparing a catalyst form recycled waste batteries, which includes the preparation of a NiCoMnOₓ composite oxide, and further extends to the preparation of a perovskite catalyst and a core-shell loaded noble catalyst.

### TECHNICAL FIELD

The present disclosure relates to the technical field of recycling waste ternary lithium power batteries and catalyst technology, particularly to a method for preparing a catalyst using recycled waste batteries and an application of the catalyst.

### BACKGROUND ART

In recent years, various countries have continued to encourage and promote the development of the new energy vehicle industry for achieving the goal of peak carbon dioxide emissions and carbon neutrality and accelerate the process of low-carbonization. Driven by both policies and markets, the new energy vehicle industry continues to develop rapidly. Many enterprises have launched many vehicle models that can meet consumer demand, and with the continuous improvement of charging and battery replacement infrastructure, the new energy vehicle industry has made significant progress. Lithium-ion batteries are the “heart” of electric vehicles, but they typically experience capacity degradation during use, and once their capacity is lower than 80% of the initial capacity, they cannot meet the normal power demand of electric vehicles. Nowadays, the early lithium-ion batteries used in electric vehicles are starting to reach the end of their service life, and it is estimated that by 2030, there will be more than 6 million tons of retired lithium-ion batteries worldwide. These retired waste lithium batteries contain chemicals such as lithium hexafluorophosphate, organic carbonates, copper, cobalt, nickel and manganese.

For a long time in the future, with the sustained high growth of the new energy vehicle market, the amount of waste power batteries will also increase. Through the centralized “harmless” treatment and “resource-based” recycling by professional recycling enterprises, green recycling can be realized, turning harm into benefit.

The recovery and utilization of waste power batteries from new energy vehicles is a path towards sustainable development and a way to achieve the goal of peak carbon dioxide emissions and carbon neutrality, with broad market prospects. Valuable metals from waste power batteries are typically recovered through hydrometallurgy, pyrometallurgy and other methods; however, these recovery processes tend to have high energy consumption.

The recovery and resource utilization of valuable metals in waste batteries will occupy a broad market for a long time. Many enterprises focus on re-manufacturing ternary lithium batteries from recovered valuable metals, but this process is lengthy. Moreover, the recycling of ternary lithium batteries faces challenges, such as complex technological process, difficult utilization of valuable components, high energy consumption and significant environmental risks.

For the recycling of waste batteries, the present application proposes that, valuable metals are extracted based on recycling valuable components from waste power batteries, and without subsequent energy-intensive process, the extracted valuable metals are used to prepare catalysts for purifying industrial exhaust gas in one or multiple steps. This approach has positive environmental impacts by using valuable metals from waste batteries to create catalysts that purify industrial exhaust, achieving “waste treatment through waste.” Additionally, it opens a new high-value recycling pathway for waste battery recovery.

### SUMMARY

The present disclosure provides a catalyst prepared from recycled waste batteries comprising a shell structure and a core structure. The core structure is prepared from valuable components of waste ternary lithium power batteries, and the core structure is composed of a composite metal oxide consisting of NiO, Co₃O₄ and MnO₂. The shell structure is a manganese dioxide layer covering a surface of the core structure, and the manganese dioxide layer is provided with at least two through-channels. There is a gap layer between the core structure and the shell structure, and noble metals Pt and/or Ru are loaded on an outer surface of the manganese dioxide layer and inside the gap layer.

According to one or more embodiments, the through-channels are formed by thermal decomposition of polymethylmethacrylate microspheres in the shell structure during calcination. The thickness of the manganese dioxide layer in the shell structure is 100 nm, the particle size of the composite metal oxide in the core structure is 200 μm, and the thickness of the gap layer is 100 μm.

According to one or more embodiments, the amounts of the noble metals Pt and Ru are 0.2% and 0.6% respectively.

According to one or more embodiments, the composite metal oxide is extracted from the waste ternary lithium power batteries, wherein the mass fraction of NiO is 20%-40%, that of Co₃O₄ is 30%-50% and that of MnO₂ is 20%-30%. In some aspects, the mass fractions of NiO, Co₃O₄ and MnO₂ in the composite metal oxide are: NiO: 20%, Co₃O₄: 50%, and MnO₂: 30%.

The present disclosure proposes a method for preparing a catalyst from recycled waste batteries, comprising the following steps:
1) extracting valuable metals from cathode materials of waste ternary lithium power batteries with an inorganic acid to form Ni, Co, and Mn precursor salts, wherein the inorganic acid is selected from the group consisting of H₂SO₄, HNO₃ and HCl;
2) adding a precipitant to the precursor salts to generate a composite metal precipitate, wherein the precipitant is selected from the group consisting of Na₂CO₃, saturated NH₄(NO₃)₂, NH₃·H₂O and NaOH;
3) calcining the composite metal precipitate to prepare a NiCoMnOₓ composite metal oxide containing NiO, Co₃O₄ and MnO₂, which is directly used for catalytic oxidation;
4) based on step 2), La(NO₃)₃·6H₂O is added to the precursor salts to prepare a perovskite catalyst with better stability;
5) pulverizing the composite metal oxide to a particle size of 200 μm-250 μm to obtain a powder of the composite metal oxide, uniformly dispersing polymethyl methacrylate microspheres, manganese dioxide particles and α-hemihydrate gypsum in anhydrous ethanol to obtain a mixed material, spraying the mixed material on a surface of the powder of the composite metal oxide, and drying to form a mixed material layer on the surface of the powder of the composite metal oxide to obtain a composite intermediate;
6) adding 0.3 g-1.2 g of potassium permanganate into 20 g⁻²⁵ g of 0.2 mol/L sodium hydroxide solution to obtain an alkaline potassium permanganate solution;
7) dispersing the composite intermediate in the anhydrous ethanol, then adding 0.2 mol/L sodium hydroxide solution, and stirring to form a suspension, wherein the mass ratio of the composite intermediate, anhydrous ethanol, and sodium hydroxide solution is 1:(80-100):(2.5-5);
8) slowly dropping the alkaline potassium permanganate solution into the suspension, wherein the volume ratio of the suspension to the alkaline potassium permanganate solution is 100:(5-10), then stirring them and allowing the reaction to proceed for 300 minutes, filtering out solids after the reaction, repeatedly washing the solids with deionized water, and then drying at 80° C. to obtain composite microspheres;
9) adding the composite microspheres into deionized water, dissolving α-hemihydrate gypsum, filtering out solids, washing the solids with deionized water to obtain a catalyst microsphere intermediate I, calcining the catalyst microsphere intermediate I at 280° C. for 2 to 3 hours, then cooling, and then adding deionized water for ultrasonic washing and drying to obtain a catalyst microsphere intermediate II;
10) immersing the catalyst microsphere intermediate II in a noble metal precursor solution, filtering out solids, then drying and grinding the solids and placing them into a tube furnace, and then introducing a 10% H₂/Ar gas mixture and maintaining at 400° C. for 4 hours to obtain a core-shell loaded noble metal catalyst.

According to one or more embodiments, in step 4), the particle size of the polymethyl methacrylate microspheres is 80 μm-100 μm, the particle size of the manganese dioxide particles is 100 nm-200 nm, the particle size of the α-hemihydrate gypsum is 5 μm-10 μm, and the thickness of the mixed material layer is 70 μm-160 μm.

According to one or more embodiments, in step 4), the mass ratio of the polymethyl methacrylate microspheres, manganese dioxide particles, α-hemihydrate gypsum, and anhydrous ethanol is 1:(0.5-1): 3: 6.

According to one or more embodiments, in step 9), the noble metal precursor solution is at least one of: H₂PtCl₆ solution and RuCl₃ solution, and the amounts of the noble metals Pt and Ru are 0.2% and 0.6% respectively.

According to one or more embodiments, the catalyst prepared from recycled waste batteries in the present disclosure can be applied to at least one of: VOCs catalytic combustion, CO oxidation and alkane catalytic oxidation.

The present application designs a high-performance core-shell loaded noble metal catalyst prepared from valuable metals Ni, Co, and Mn in recycled waste ternary lithium power batteries, realizing the resource utilization of the waste batteries, protecting the environment and reducing the production cost of the catalyst. The prepared core-shell loaded noble metal catalyst comprises a composite metal oxide of the core structure, a manganese dioxide layer of the shell structure and a gap layer between the core structure and the shell structure. The core-shell structure of the core-shell loaded noble metal catalyst enables the catalyst to have a higher specific surface area and more active sites, which is beneficial to the catalytic reaction, meanwhile, the manganese dioxide layer in the shell structure is provided with through-channels, which further improve the mass transfer efficiency of the catalyst, making it easier for reactants to contact the active sites. The noble metals Pt and/or Ru are loaded on the outer surface of the manganese dioxide layer and inside the gap layer, which improves the utilization rate of the noble metals and enhances the catalytic activity and stability of the catalyst, making it exhibit excellent catalytic effects in VOCs catalytic combustion, CO oxidation and alkane catalytic oxidation.

### BRIEF DESCRIPTION OF THE DRAWING

FIG. 1 is a performance diagram of the NiCoMnOₓ composite metal oxide prepared in Example 1 in the catalytic oxidation of carbon monoxide and in the catalytic oxidation of toluene, wherein the NiCoMnOₓ composite metal oxide is prepared from the valuable metals of the cathode materials that are extracted with H₂SO₄;

FIG. 2 is a performance diagram of the NiCoMnOₓ composite metal oxide prepared in Example 2 in the catalytic oxidation of carbon monoxide and in the catalytic oxidation of toluene, wherein the NiCoMnOₓ composite metal oxide is prepared from the valuable metals of the cathode materials that are extracted with HNO₃.

FIG. 3 is a performance diagram of the NiCoMnOₓ composite metal oxide prepared in Example 3 in the catalytic oxidation of carbon monoxide and in the catalytic oxidation of toluene, wherein the NiCoMnOₓ composite metal oxide is prepared from the valuable metals of the cathode materials that are extracted with HCl.

FIG. 4 is a performance diagram of the NiCoMnOₓ composite metal oxide prepared in Example 4 in the catalytic oxidation of carbon monoxide and in the catalytic oxidation of toluene, wherein the NiCoMnOₓ composite metal oxide is prepared from the valuable metals of the cathode materials that are extracted with citric acid.

FIG. 5 is a performance diagram of a LaNiCoMnO₃ perovskite catalyst prepared in Example 5 in the catalytic oxidation of carbon monoxide and in the catalytic oxidation of toluene.

FIG. 6 is a performance diagram of Pt/NiCoMnOₓ catalyst prepared by loading noble metal Pt on NiCoMnOₓ composite metal oxide prepared in Examples 1 to 3 in the catalytic oxidation of carbon monoxide.

FIG. 7 is a performance diagram of Ru/NiCoMnOₓ catalyst prepared by loading noble metal Ru on NiCoMnOₓ composite metal oxide prepared in Examples 1 to 3 in the catalytic oxidation of carbon monoxide.

FIG. 8 is a performance diagram of Pt/NiCoMnOₓ catalyst prepared by loading noble metal Pt on NiCoMnOₓ composite metal oxide prepared in Examples 1 to 3 in the catalytic oxidation of toluene.

FIG. 9 is a performance diagram of Ru/NiCoMnOₓ catalyst prepared by loading noble metal Ru on NiCoMnOₓ composite metal oxide prepared in Examples 1 to 3 in the catalytic oxidation of toluene.

### DETAILED DESCRIPTION

The embodiments of the present application will be described below with reference to related embodiments. The embodiments of the present application are not limited to the following embodiments, and any necessary components related to the technical field of this application should be regarded as well-known technology in this technical field and can be known and mastered by those skilled in the art.

The present application provides a catalyst prepared by using recycled waste batteries, comprising a shell structure and a core structure prepared from valuable components of waste ternary lithium power batteries. The core structure is composed of a composite metal oxide consisting of NiO, Co₃O₄ and MnO₂. The shell structure is a manganese dioxide layer covering a surface of the core structure, and the manganese dioxide layer is provided with at least two through-channels. There is a gap layer between the core structure and the shell structure, and noble metals Pt and/or Ru are loaded on an outer surface of the manganese dioxide layer and inside the gap layer.

According to one or more embodiments, the through-channels are formed by thermal decomposition of polymethylmethacrylate microspheres in the shell structure during calcination. The thickness of the manganese dioxide layer in the shell structure is 100 nm, the particle size of the composite metal oxide in the core structure is 200 μm, and the thickness of the gap layer is 100 μm.

According to one or more embodiments, the amounts of the noble metals Pt and Ru are 0.2% and 0.6% respectively.

According to one or more embodiments, the composite metal oxide is extracted from the waste ternary lithium power batteries. In the composite metal oxide, the mass fraction of NiO is 20%-40%, Co₃O₄ is 30%-50% and MnO₂ is 20%-30%. In some aspects, the mass fractions of NiO, Co₃O₄ and MnO₂ are: NiO: 20%, Co₃O₄: 50%, and MnO₂: 30%.

The core structure of the catalyst is composed of the composite metal oxide consisting of NiO, Co₃O₄ and MnO₂, which can provide excellent electron transfer capability and structural stability; the shell structure is the manganese dioxide layer covering the surface of the core structure, which can increase the specific surface area of the catalyst and thereby improve the catalytic activity; the gap layer between the core structure and the shell structure helps to relieve thermal stress and prevent the catalyst from structural collapse at high temperatures; and the through-channels formed by thermal decomposition of polymethyl methacrylate microspheres in the shell structure during calcination can provide fast transport paths for reactants and products, thereby reducing diffusion resistance and improving the reaction rate and efficiency of the catalyst. Besides, the noble metals Pt and Ru are loaded on the outer surface of the manganese dioxide layer and inside the gap layer, which can make full use of the catalytic activity of the noble metals and reduce the cost.

In the structure of a core-shell loaded noble metal catalyst, the thickness of the shell structure is 100 nm and the particle size of the core structure is 200 μm, which is helpful to balance the catalytic activity and stability of the catalyst; a shell structure that is too thin may result in insufficient protection, while a shell structure that is too thick may hinder material transmission. The core structure has a moderate particle size that can provide sufficient active sites without increasing the cost due to excessive size. The thickness of the gap layer is 100 μm, which can provide enough space to buffer the stress caused by thermal expansion, thereby preventing the catalyst from being damaged by thermal stress during application. The amounts of Pt and Ru are limited to 0.2% and 0.6%, respectively, which can maximize the conservation of expensive noble metal resources while ensuring the catalyst activity. The composition of the composite metal oxide, with specific mass fractions of 20% NiO, 50% C0304, and 30% MnO₂, optimizes the electronic structure, enhancing the selectivity and stability of the catalyst.

The present application proposes a method for preparing a catalyst by using recycled waste batteries, comprising the following steps:
Step 1) Extracting valuable metals from cathode materials of waste ternary lithium power batteries with an inorganic acid to form Ni, Co, and Mn precursor salts, wherein the inorganic acid is selected from the group consisting of H₂SO₄, HNO₃ and HCl.
Step 2) Adding a precipitant to the precursor salts to generate a composite metal precipitate, wherein the precipitant is selected from the group consisting of Na₂CO₃, saturated NH₄(NO₃)₂, NH₃·H₂O and NaOH.
Step 3) Calcining the composite metal precipitate to prepare a NiCoMnOₓ composite metal oxide containing NiO, Co₃O₄ and MnO₂.
Step 4) Pulverizing the composite metal oxide with a grinder to a particle size of 200 μm to obtain a powder of the composite metal oxide; dispersing uniformly polymethyl methacrylate microspheres, manganese dioxide particles and α-hemihydrate gypsum in anhydrous ethanol to obtain a mixed material, wherein the mass ratio of polymethyl methacrylate microspheres, manganese dioxide particles, α-hemihydrate gypsum, and anhydrous ethanol in the mixed material is 1:0.5:3: 3; and spraying the mixed material on a surface of the powder of the composite metal oxide, drying it, and controlling a spraying thickness to form a mixed material layer with a thickness of 100 μm on the surface of the powder of the composite metal oxide to obtain a composite intermediate. The particle size of the polymethyl methacrylate microspheres is 80 μm, the particle size of the manganese dioxide particles is 100 nm, and the particle size of the α-hemihydrate gypsum is 10 μm. In the mixed material layer, the manganese dioxide particles and the polymethyl methacrylate microspheres are fixed on the surface of the composite metal oxide through the α-hemihydrate gypsum, and the manganese dioxide particles in the α-hemihydrate gypsum serve as seeds for the growth of the manganese dioxide layer, providing growth sites for the formation of the manganese dioxide layer.

Step 5) Adding 1.2 g of potassium permanganate into 25 g of a 0.2 mol/L sodium hydroxide solution to obtain an alkaline potassium permanganate solution;

Step 6) Dispersing the composite intermediate in anhydrous ethanol, then adding 0.2 mol/L sodium hydroxide solution, and stirring to form a suspension, wherein the mass ratio of the composite intermediate, anhydrous ethanol, and sodium hydroxide solution is 1:100: 2.5.

Step 7) Dropping slowly the alkaline potassium permanganate solution into the suspension, wherein the volume ratio of the suspension to the alkaline potassium permanganate solution is 100:10; stirring them and allowing the reaction to proceed for 300 minutes; and filtering out solids after the reaction is complete, repeatedly washing the solids with deionized water, and then drying at 80° C. to obtain composite microspheres;

Step 8) Adding the composite microspheres into the deionized water, dissolving the α-hemihydrate gypsum, thereby forming a gap layer between the shell structure and the core structure of the catalyst; filtering out solids, washing the solids with deionized water to obtain a catalyst microsphere intermediate I, calcining the catalyst microsphere intermediate I at 280° C. for 2 to 3 hours, and thermally decomposing the polymethylmethacrylate microspheres on the manganese dioxide layer, thereby leaving the through-channels on the manganese dioxide layer, then cooling, and then adding deionized water for ultrasonic washing and drying to obtain a catalyst microsphere intermediate II;

Step 9) Immersing the catalyst microsphere intermediate II in a noble metal precursor solution, filtering out solids, drying, and grinding the solids and placing them into a tube furnace, and then introducing a 10% H₂/Ar gas mixture and maintaining at 400° C. for 4 hours to obtain the catalyst, wherein the noble metal precursor solution is a Pt(NO₃)₂ or RuCl₃ solution, with the amounts of noble metals Pt and Ru being 0.2% and 0.6% respectively.

A core-shell noble metal-loaded composite metal oxide catalyst can be prepared by the above method, wherein the core structure is a composite metal oxide of NiO—Co₃O₄—MnO₂, and the proportion of each component in the composite metal oxide is NiO: 20%, CO₃O₄: 50%, and MnO₂: 30%; the shell structure is a manganese dioxide layer provided with at least two through-channels, and there is a gap layer between the core structure of the composite metal oxide and the shell structure of the manganese dioxide layer; and the noble metal Pt or Ru are loaded on the outer surface of the manganese dioxide layer and inside the gap layer between the core structure of the composite metal oxide and the shell structure of the manganese dioxide layer.

The manganese dioxide layer in the shell structure has a surface rich in active sites, allowing manganese dioxide to act as a mediator for electron transfer, facilitating the transfer of electrons between reactants and products. These active sites on the surface of the manganese dioxide layer adsorb and activate reactant molecules, reducing the activation energy of the reaction, and thereby accelerating the chemical reaction. The interfacial effect of the interaction between the manganese dioxide layer and the noble metal Pt or Ru loaded on it can further enhance the catalytic activity of the catalyst, allowing the catalyst to achieve a high catalytic efficiency at a much lower temperature.

The composite metal oxide of NiO—Co₃O₄—MnO₂ in the core structure includes manganese, a transition metal with easily variable oxidation states and strong oxidizing properties, which helps enhance the catalyst's catalytic performance. Meanwhile, its active components have strong oxidizing properties and can effectively purify pollutants in the exhaust gas. The introduced cobalt can increase the transfer rate of oxygen, promoting catalytic oxidation in reactions. NiO offers excellent anti-sintering properties, which can ensure that it is not easy to sinter at high temperature and improve the catalyst's resistance to carbon deposition.

In the core-shell noble metal-loaded composite metal oxide catalyst of the present application, the manganese dioxide layer adsorbs reactant molecules during a catalytic reaction. When the reactants are close to the manganese dioxide layer, a portion of the reactant molecules directly react with the noble metals on the surface of the manganese dioxide layer, and another portion of the reactant molecules enter into the gap layer between the core structure of the composite metal oxide and the shell structure of the manganese dioxide layer through the through-channels on the surface of the manganese dioxide layer, thereby limiting the disordered movement of the reactant molecules in the reaction system, increasing the effective collision of the reactant molecules with the noble metals in the gap layer, and improving the catalytic activity of the catalyst.

In the method for preparing the catalyst of the present application, steps 1) to 3) provide a method for preparing composite metal oxides from noble metals of waste ternary lithium power batteries.

In step 1), firstly, extracting lithium carbonate extracted by carbon pre-reduction, and after separating the lithium, extracting valuable metals from the cathode materials of waste ternary lithium power batteries with inorganic acid to form Ni, Co, and Mn precursor salts, wherein the inorganic acid is selected from the group consisting of H₂SO₄, HNO₃ and HCl. In some aspects, the inorganic acid is HNO₃.

In step 2), preparing the composite metal precipitate from the precursor salts using a precipitant, wherein the precipitant is selected from the group consisting of Na₂CO₃, saturated NH₄(NO₃)₂, NH₃·H₂O and NaOH.

In step 3), calcining the composite metal precipitate to prepare a composite metal oxide containing NiO, Co₃O₄ and MnO₂.

According to one or more embodiments, the method for preparing the composite metal oxide by extracting valuable metals from the cathode materials of the waste ternary lithium power batteries with the inorganic acid comprises the following steps: placing the cathode material of waste power batteries in nitric acid and extracting valuable metals under heating conditions to obtain leaching solution, wherein the leaching solution is treated with precipitants selected from the group consisting of (NH₄)₂CO₃, NH₃·H₂O, Na₂CO₃ and NaOH, with an excess of 1 to 2 times the molar amount of the metal; after precipitation, the pH value of the solution is adjusted to 9 to 10 with NaOH. Following aging, filtration, drying, and calcination steps, the composite metal oxide is obtained.

According to one or more embodiments, in step 1), organic acid can be used instead of inorganic acid to extract valuable metals from the cathode material of waste ternary lithium power batteries to prepare the composite metal oxides. The organic acid is selected from the group consisting of citric acid, tartaric acid and ascorbic acid. In some aspects, the citric acid is used to extract valuable metals. In some examples, the composite metal oxide can be prepared by a one-step method. The preparation process of preparing the composite metal oxide by extracting valuable metals with the citric acid is as follows: the Ni, Co and Mn precursor salts extracted with the citric acid directly form a gel in a water bath at 80° C., and the gel is then dried and calcined to obtain the composite metal oxide.

The composite metal oxide of the present disclosure, which is obtained by extracting valuable metals from the cathode materials of waste ternary lithium batteries using inorganic or organic acids, can be used as a catalyst for the catalytic oxidation of organic substances such as toluene and CO. Additionally, the composite metal oxide can also be used as a carrier to prepare a noble metal catalyst with better catalytic activity by loading noble metals such as Pt, Pd and Ru.

According to one or more embodiments, in the process of preparing the composite metal oxide by using valuable metals extracted from the cathode materials of waste ternary lithium power batteries with inorganic or organic acid, a structured catalyst can be prepared by adding precursor salts, and the preparation method is as follows:
1) extracting valuable metals from the cathode materials of waste batteries with the citric acid, and preparing the composite metal oxide by one-step method;
2) adding precursor salts, such as La(NO₃)₃·6H₂O, and preparing a perovskite or spinel catalyst by one-step method;
3) using the composite metal oxide or catalyst with special structure prepared by one-step method as a carrier for impregnating other active components to produce a catalyst with enhanced catalytic performance.

For organic acid that extracts valuable metals from the cathode material, the citric acid not only acts as an acid for extracting valuable metals from the cathode material, but also acts as a complexing agent in the preparation process of the catalyst, which can greatly simplify the extraction of valuable components and the preparation process of the catalyst.

In the preparation process of preparing the composite metal oxide by leaching with the citric acid, the citric acid can be used not only as an extractant but also as a complexing agent for preparing catalysts. La(NO₃)₃·6H₂O is added as an A-site element in the leaching solution to prepare the perovskite or spinel catalysts. The citric acid, which is already present in the leaching process, is used as the complexing agent without the need for additional additives. In the NiCoMnOₓ composite metal oxide prepared by leaching with the citric acid, the molar fractions of La₂O₃, NiO, MnO₂ and Co₃O₄ are as follows: the molar fraction of La₂O₃ is 50%, and the molar fractions of NiO, MnO₂ and Co₃O₄ are 10%-30%.

The perovskite or spinel structural catalysts provided herein can be used directly as catalysts for the catalytic oxidation of organic substances such as toluene and CO, and can also be used as a carrier for impregnating noble metals such as Pt, Pd, and Ru, to prepare noble metal catalysts with enhanced catalytic performance.

The present application also relates to the application of catalysts prepared from the recycled waste batteries. The following provides a detailed description of the catalysts, their preparation methods and applications provided herein in conjunction with embodiments, but they should not be understood as limiting the scope of protection of the present disclosure. The catalysts prepared from the valuable metals from the recycled waste batteries are tested for their performance in the catalytic oxidation of toluene and of CO at 20000 ml·g⁻¹·h⁻¹.

### Example 1

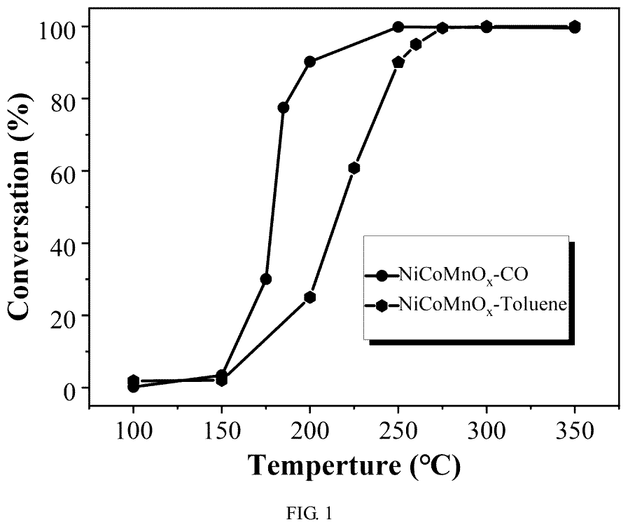

In this example, 1.5 mol/L H₂SO₄ is used to extract valuable metals from the cathode materials of waste batteries, and H₂O₂ is used as a reducing agent, with a solid-liquid ratio of 20 g/L. Firstly, 10 g of LiNi_{0.5}Co_{0.2}Mn_{0.3}O₂ is dissolved in a 500 mL beaker, with adding H₂SO₄ and H₂O₂, and the valuable metals are extracted from the cathode materials at 80° C., then filtering them to obtain leaching solution. (NH₄)₂CO₃ is added as a precipitant into the leaching solution, wherein metal: precipitant=1:2 (molar ratio). After precipitation, the pH value of the solution is adjusted to 9-10 with 30% NH₃·H₂O, following by stirring for 1 hour. After stirring, the precipitate is aged in a water bath at 80° C. for 5 hours. After ageing followed by filtration, washing and drying, the precipitate is calcined at 600° C. for 4 hours at a heating rate of 3° C./min. Finally, a NiCoMnOₓ composite metal oxide is prepared and the performance of the NiCoMnOₓ composite metal oxide in the catalytic oxidation of toluene and of CO is shown in FIG. 1.

### Example 2

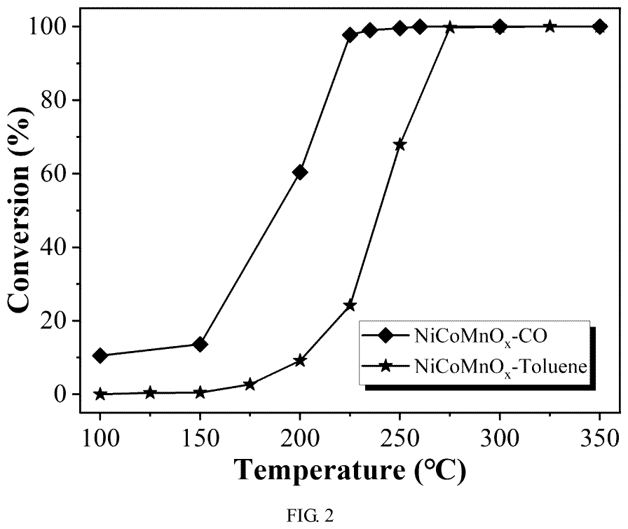

In this example, 1 mol/L HNO₃ is used to extract valuable metals from the cathode materials of waste batteries, and H₂O₂ is used as a reducing agent. Firstly, 15 g of LiNi_{0.5}Co_{0.2}Mn_{0.3}O₂ is dissolved in a 500 mL beaker, with adding HNO₃ and H₂O₂, and the valuable metals are extracted from the cathode materials at 80° C., then filtering them to obtain leaching solution. Na₂CO₃ is added as a precipitant into the leaching solution, wherein metal: precipitant is 1:2 (molar ratio). After precipitation, the pH value of the solution is adjusted to 9-10 with 1 mol/L NaOH, following by stirring for 1 hour. After stirring, the precipitate is aged in a water bath at 80° C. for 5 hours. After ageing followed by filtration, washing and drying, the precipitate is calcined at 600° C. for 4 hours at a heating rate of 3° C./min. Finally, a NiCoMnOₓ composite metal oxide is prepared and the performance of the NiCoMnOₓ composite metal oxide in the catalytic oxidation of toluene and of CO is shown in FIG. 2.

### Example 3

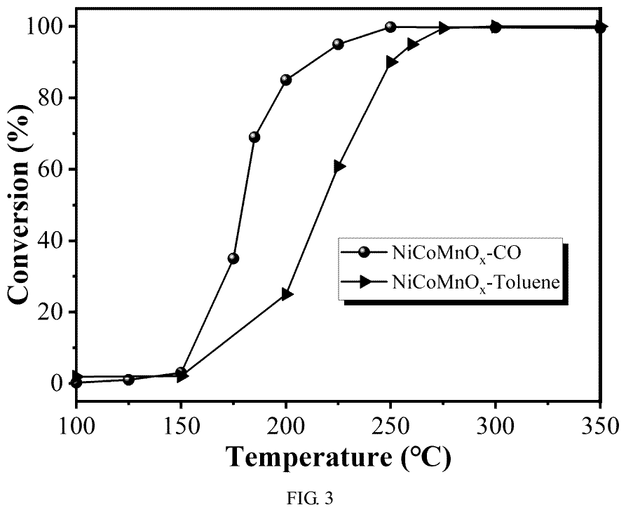

In this example, 1 mol/L HCL is used to extract valuable metals from the cathode materials of waste batteries, and H₂O₂ is used as a reducing agent. Firstly, 10 g of LiNi_{0.5}Co_{0.2}Mn_{0.3}O₂ is dissolved in a 500 ml beaker, with adding HCL and H₂O₂, and the valuable metals are extracted from the cathode materials at 80° C., then filtering them to obtain leaching solution. Na₂CO₃ is added as a precipitant into the leaching solution, wherein metal: precipitant is 1:2 (molar ratio). After precipitation, the pH value of the solution is adjusted to 9-10 with 1 mol/L NaOH, following by stirring for 1 hour. After stirring, the precipitate is aged in a water bath at 80° C. for 5 hours. After ageing followed by filtration, washing and drying, the precipitate is calcined at 600° C. for 4 hours at a heating rate of 3° C./min. Finally, a NiCoMnOₓ composite metal oxide is prepared and the performance of the NiCoMnOₓ composite metal oxide in the catalytic oxidation of toluene and of CO is shown in FIG. 3.

### Example 4

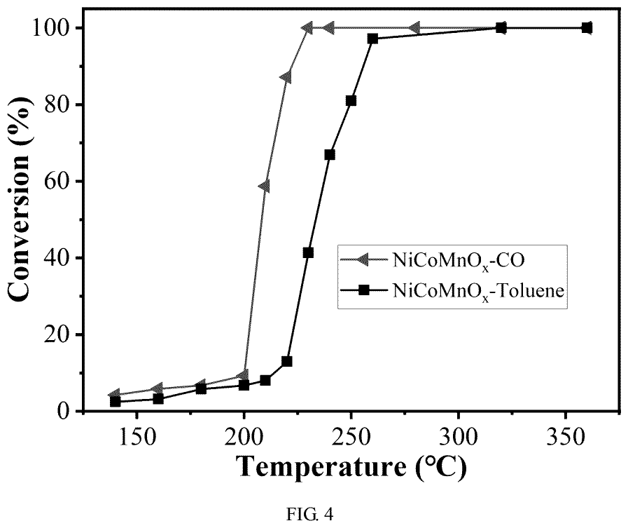

In this example, the citric acid is used to extract valuable metals from the cathode materials of waste batteries. Firstly, 10 g of LiNi_{0.5}Co_{0.2}Mn_{0.3}O₂ is mixed evenly with activated carbon and then calcined at 600° C. The calcined cathode materials are dissolved in a 500 mL beaker, with adding the citric acid, wherein the metal: citric acid is 1:1-1:2. The valuable metals are extracted from the cathode materials at 80° C. with the reducing agent H₂O₂, and filtered after extraction. The filtered solution is continuously stirred in a water bath at 80° C. until a gel is formed, and the gel is calcined at 600° C. for 4 hours to dry, with a heating rate of 2° C./min. Finally, a NiCoMnOₓ composite metal oxide is prepared and the performance of the NiCoMnOₓ composite metal oxide in the catalytic oxidation of toluene and of CO is shown in FIG. 4.

### Example 5

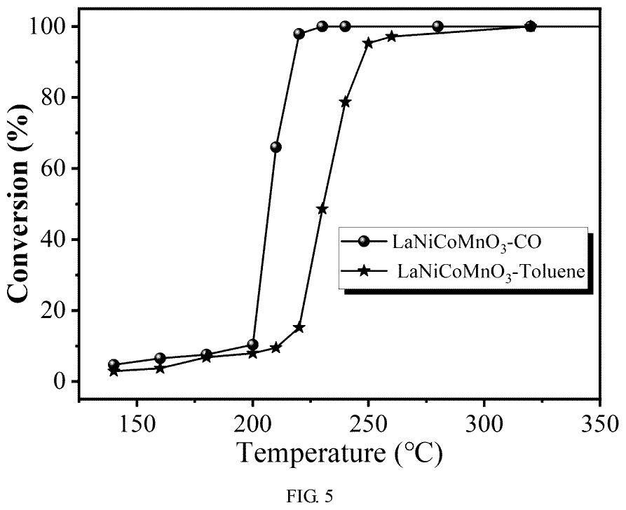

In this example, the citric acid is used to extract valuable metals from the cathode materials of waste batteries. Firstly, 10 g of LiNi_{0.5}Co_{0.2}Mn_{0.3}O₂ is mixed evenly with activated carbon and then calcined at 600° C. The calcined cathode materials are dissolved in a 500 mL beaker, and the valuable metals are extracted from the cathode materials at 80° C. After extraction, the mixture is filter to obtain a solution, with adding the citric acid and La(NO₃)₃·6H₂O into the solution, wherein n (La(NO₃)₃·6H₂O): n (citric acid): n (Ni²⁺+Co³⁺+Mn²⁺)=1:2: 1. The filtered solution is continuously stirred in a water bath at 80° C. until a gel is formed, and the gel is calcined at 600° C. for 4 hours to dry, with a heating rate of 2° C./min. Finally, a perovskite catalyst LaNi_{0.5}Co_{0.2}Mn_{0.3}O₃ is prepared and the performance of the perovskite catalyst LaNi_{0.5}Co_{0.2}Mn_{0.3}O₃ in the catalytic oxidation of toluene and of CO is shown in FIG. 5.

### Example 6

On the basis of maintaining good toluene and CO conversion, the NiCoMnOₓ composite metal oxide prepared in Examples 1 to 3 is determined to load 0.2% Pt and 0.6% Ru respectively through experiments and considering the cost of noble metals.

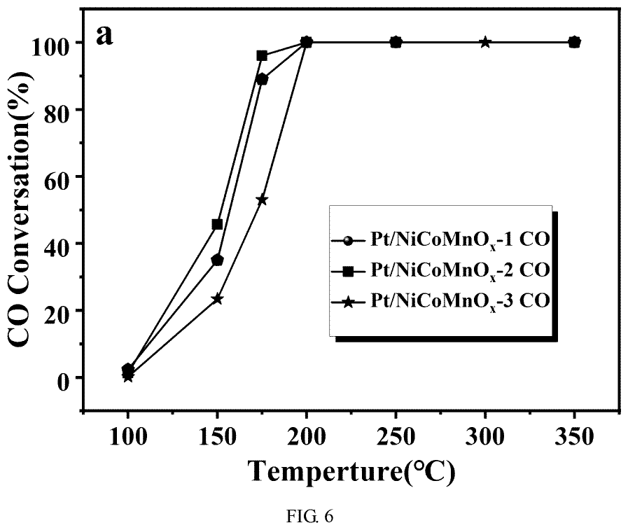

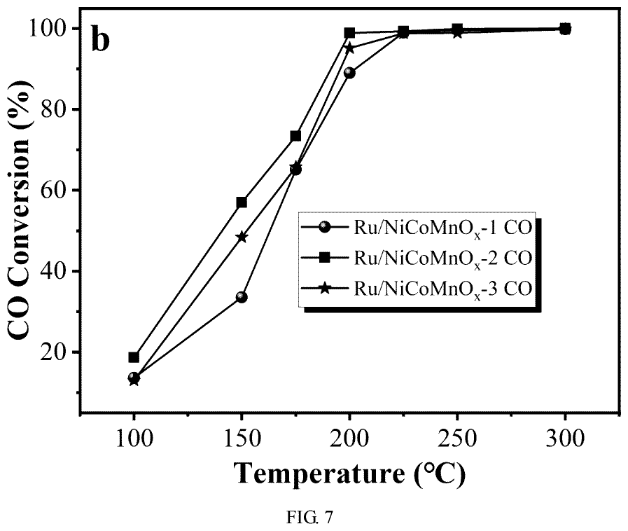

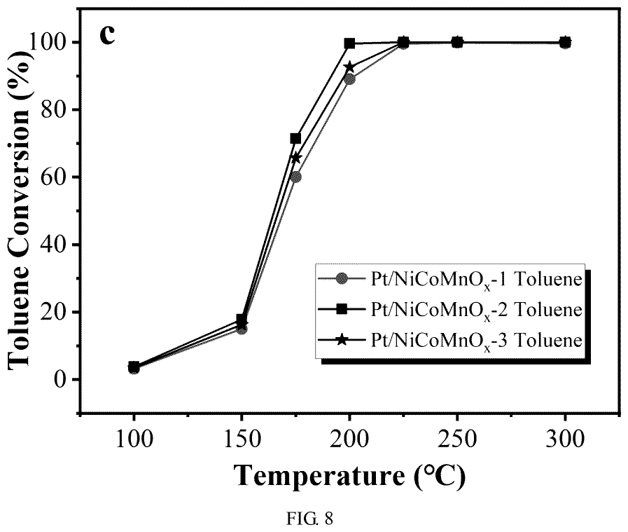

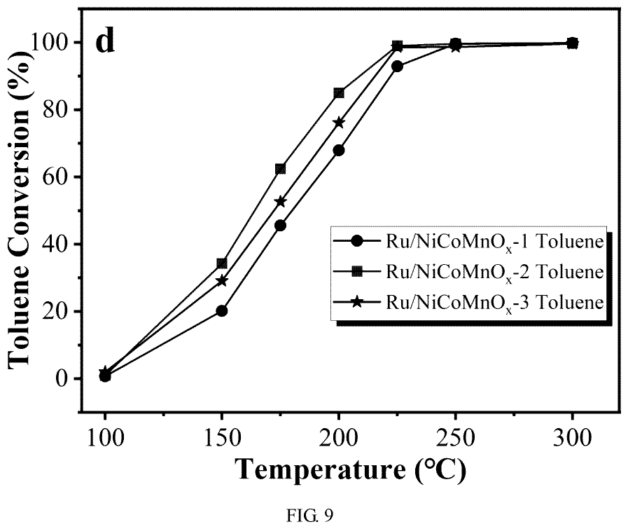

The catalysts, which are prepared from the NiCoMnOₓ composite metal oxides prepared in Examples 1-3 after loading the noble metal Pt or Ru, are labelled as Pt/NiCoMnOₓ-1, Pt/NiCoMnOₓ-2, Pt/NiCoMnOₓ-3, Ru/NiCoMnOₓ-1, Ru/NiCoMnOₓ-2 and Ru/NiCoMnOₓ-3, respectively, and the performance of these six catalysts in the catalytic oxidation of toluene and of CO are measured, the results of which are shown in FIGS. 6 to 9.

### Example 7

Using the composite metal oxides prepared in Examples 1-3 as the core structure, corresponding catalysts are prepared according to the method herein for preparing the core-shell loaded noble metal catalyst, in which the amounts of the noble metals Pt and Ru are 0.2% and 0.6% respectively.

The core-shell loaded noble metal catalysts loaded with Pt or Ru, respectively, are prepared using the composite metal oxide prepared in Example 1 as the core structure, and correspondingly labelled as Pt/NiCoMnOₓ(I)—Pt/MnO₂ and Ru/NiCoMnOₓ(I)—Ru/MnO₂.

The core-shell loaded noble metal catalysts loaded with Pt or Ru, respectively, are prepared using the composite metal oxide prepared in Example 2 as the core structure, and correspondingly labelled as Pt/NiCoMnOₓ(II)—Pt/MnO₂ and Ru/NiCoMnOₓ(II)—Ru/MnO₂.

The core-shell loaded noble metal catalysts loaded with Pt or Ru, respectively, are prepared using the composite metal oxide prepared in Example 3 as the core structure, and correspondingly labelled as Pt/NiCoMnOₓ(III)—Pt/MnO₂ and Ru/NiCoMnOₓ(III)—Ru/MnO₂.

The performance comparison table of the catalysts prepared in Example 6 and Example 7 for the catalytic oxidation of carbon monoxide and of toluene is shown below:

| | | Temperature (CO | Temperature (toluene |
|---|---|---|---|
| Example | Catalyst | conversion: 100%)/° C. | conversion: 100%)/° C. |
| Example 6 | Pt/NiCoMnOₓ-1 | 200° C. | 300° C. |
| | Pt/NiCoMnOₓ-2 | 200° C. | 300° C. |
| | Pt/NiCoMnOₓ-3 | 200° C. | 300° C. |
| | Ru/NiCoMnOₓ-1 | 250° C. | 300° C. |
| | Ru/NiCoMnOₓ-2 | 250° C. | 300° C. |
| | Ru/NiCoMnOₓ-3 | 250° C. | 300° C. |
| Example 7 | Pt/NiCoMnOx(I)-Pt/MnO₂ | 180° C. | 260° C. |
| | Pt/NiCoMnOx(II)-Pt/MnO₂ | 180° C. | 260° C. |
| | Pt/NiCoMnOx(III)-Pt/MnO₂ | 180° C. | 260° C. |
| | Ru/NiCoMnOx(I)-Pt/MnO₂ | 220° C. | 250° C. |
| | Ru/NiCoMnOx(II)-Pt/MnO₂ | 220° C. | 250° C. |
| | Ru/NiCoMnOx(III)-Pt/MnO₂ | 220° C. | 250° C. |

The catalyst prepared in Example 6 is a NiO—Co₃O₄—MnO₂ composite metal oxide loaded with the noble metal Pt or Ru on the surface, and the noble metal is directly deposited on the surface of the composite metal oxide without an obvious intermediate layer or shell structure. The catalyst prepared in Example 7 adopts a core-shell structure, in which the NiO—Co₃O₄—MnO₂ composite metal oxide is the core and the outer layer is covered with a manganese dioxide layer provided with at least two through-channels. The core-shell structure forms a gap layer between the core structure and the shell structure, in which the noble metal Pt or Ru is not only loaded on the outer surface of the manganese dioxide layer, but also distributed in the gap layer between the core structure and the shell structure.

From the analysis of the performance of the catalysts prepared in Example 6 and Example 7 in the catalytic oxidation of carbon monoxide and of toluene, it can be concluded that the core-shell loaded noble metal catalyst prepared in Example 7 has better performance in catalytic oxidation. In the conversion of CO, the catalyst prepared in Example 7 can achieve 100% conversion at lower temperatures (180° C. and 220° C.), while the catalyst prepared in Example 6 needs to achieve the same conversion at 200° C. and 250° C. In the conversion of toluene, the catalyst prepared in Example 7 can also achieve 100% conversion at lower temperatures (260° C. and 250° C.), while the catalyst prepared in Example 6 needs to achieve the same conversion at 300° C.

This indicates that core-shell loaded noble metal catalyst has higher catalytic efficiency and lower catalytic temperatures, which may be due to the core-shell structure providing more active sites, and the gap layer between the shell structure of the manganese dioxide layer and the core structure of the composite metal oxide facilitating effective collision of reactant molecules, thereby improving the performance in catalytic oxidation.

The structure of core-shell loaded noble metal catalyst significantly improved its performance in catalytic oxidation. In Example 7, the shell structure of the manganese dioxide layer can provide abundant active sites to promote electron transfer and activation of reactant molecules, thereby accelerating the chemical reaction.

In addition, the interface effect between the manganese dioxide layer and its loaded noble metal Pt or Ru further enhances the catalytic activity of the catalyst. Meanwhile, in the core-shell loaded noble metal catalyst, there exists a gap layer between the core structure of the composite metal oxide and the shell structure of the manganese dioxide layer, and the gap layer is able to restrict the disordered movement of reactant molecules in the reaction system, increase the effective collisions between reactant molecules and noble metals within the gap layer, and thereby improve the catalytic performance.

It should be noted that, for those skilled in the art, various improvements and modifications can be made to the embodiments of the present disclosure without departing from the principles of the present disclosure, and these improvements and modifications should also be considered as within the scope of protection of the present disclosure.

What is claimed is:

1. A catalyst prepared from recycled waste batteries, comprising:
a shell structure,
a core structure prepared from valuable components of waste ternary lithium power batteries, and
a gap layer between the core structure and the shell structure,
wherein the core structure is composed of a composite metal oxide consisting of NiO, Co₃O₄ and MnO₂,
wherein the shell structure is a manganese dioxide layer covering a surface of the core structure, and the manganese dioxide layer is provided with at least two through-channels,
wherein noble metals Pt and/or Ru are loaded on an outer surface of the manganese dioxide layer and inside the gap layer.

2. The catalyst according to claim 1, wherein the through-channels are formed by thermal decomposition of polymethylmethacrylate microspheres in the shell structure during calcination.

3. The catalyst according to claim 1, wherein the noble metals Pt and Ru have amounts of 0.2% and 0.6% respectively.

4. The catalyst according to claim 1, wherein the composite metal oxide is extracted from the waste ternary lithium power batteries, wherein a mass fraction of NiO is 20%-40%, a mass fraction of Co₃O₄ is 30%-50% and a mass fraction of MnO₂ is 20%-30%.

5. The catalyst according to claim 4, wherein the mass fractions of NiO, Co₃O₄ and MnO₂ in the composite metal oxide are 20% NiO, 50% Co₃O₄, and 30% MnO₂.

6. A method for preparing a catalyst form recycled waste batteries, comprising:
extracting valuable metals from cathode materials of waste ternary power batteries with an inorganic acid to form Ni, Co, and Mn precursor salts, wherein the inorganic acid is selected from the group consisting of H₂SO₄, HNO₃ and HCl;
adding a precipitant to the precursor salts to generate a composite metal precipitate, wherein the precipitant is selected from the group consisting of Na₂CO₃, saturated NH₄(NO₃)₂, NH₃·H₂O and NaOH;
calcining the composite metal precipitate to prepare a NiCoMnOₓ composite metal oxide containing NiO, Co₃O₄ and MnO₂;
pulverizing the composite metal oxide to a particle size of 200 μm-250 μm to obtain a powder of the composite metal oxide, uniformly dispersing polymethyl methacrylate microspheres, manganese dioxide particles and α-hemihydrate gypsum in anhydrous ethanol to obtain a mixed material, spraying the mixed material on a surface of the powder of the composite metal oxide, and drying to form a mixed material layer on the surface of the powder of the composite metal oxide to obtain a composite intermediate;
adding 0.3 g-1.2 g of potassium permanganate into 20 g-25 g of 0.2 mol/L sodium hydroxide solution to obtain an alkaline potassium permanganate solution;
dispersing the composite intermediate in the anhydrous ethanol, then adding 0.2 mol/L sodium hydroxide solution, and stirring to form a suspension, wherein a mass ratio of the composite intermediate, the anhydrous ethanol, and the sodium hydroxide solution is 1:(80-100):(2.5-5);
dropping slowly the alkaline potassium permanganate solution into the suspension, wherein the volume ratio of the suspension to the alkaline potassium permanganate solution is 100:(5-10), then stirring them and allowing the reaction to proceed for 300 minutes, filtering out a first solid after the reaction, repeatedly washing the first solid with deionized water, and then drying at 80° C. to obtain composite microspheres;
adding the composite microspheres into deionized water, dissolving α-hemihydrate gypsum, filtering out a second solid, washing the second solid with deionized water to obtain a catalyst microsphere intermediate I, calcining the catalyst microsphere intermediate I at 280° C. for 2 to 3 hours, then cooling, and then adding deionized water for ultrasonic washing and drying to obtain a catalyst microsphere intermediate II;
immersing the catalyst microsphere intermediate II in a noble metal precursor solution, filtering out a third solid, then drying and grinding the third solid and placing them it into a tube furnace, and then introducing a 10% H₂/Ar gas mixture and maintaining at 400° C. for 4 hours to obtain a core-shell loaded noble metal catalyst.

7. The method according to claim 6, wherein, a particle size of the polymethyl methacrylate microspheres is 80 μm-100 μm, a particle size of the manganese dioxide particles is 100 nm-200 nm, a particle size of the α-hemihydrate gypsum is 5 μm-10 μm, and a thickness of the mixed material layer is 70 μm-160 μm.

8. The method according to claim 6, wherein, a mass ratio of the polymethyl methacrylate microspheres, the manganese dioxide particles, the α-hemihydrate gypsum, and the anhydrous ethanol is 1:(0.5-1): 3: 6.

9. The method according to claim 6, wherein, the noble metal precursor solution is at least one of: H₂PtCl₆ or RuCl₃ solution, and wherein the noble metals Pt and Ru have amounts of 0.2% and 0.6% respectively.

10. Use of the catalyst according to claim 1 for catalysis of at least one of: VOCs catalytic combustion, CO oxidation and alkane catalytic oxidation.
